(19) United States
(12) Patent Application Publication
(10) Pub. No.: US 2014/0320251 A1
(43) Pub. Date: Oct. 30, 2014

(54) THIN FILM CHIP DEVICE AND METHOD FOR MANUFACTURING THE SAME

(71) Applicant: Samsung Electro-Mechanics Co., Ltd., Suwon-Si (KR)

(72) Inventors: Jin Hyuck YANG, Suwon-Si (KR); Young Seuck YOO, Suwon-Si (KR); Jeong Min CHO, Suwon-Si (KR); Ji Hoon PARK, Suwon-Si (KR); Kyong Bok MIN, Suwon-Si (KR); Young Do KWEON, Suwon-Si (KR); Jong Yun LEE, Suwon-Si (KR)

(73) Assignee: SAMSUNG ELECTRO-MECHANICS CO., LTD., Suwon-Si (KR)

(21) Appl. No.: 14/259,953

(22) Filed: Apr. 23, 2014

(30) Foreign Application Priority Data
Apr. 26, 2013 (KR) 10-2013-0046732

(51) Int. Cl. H01F 27/28; H01F 41/04

(52) U.S. Cl. CPC H01F 27/2804; H01F 41/042; H01F 2027/2809
USPC 336/200; 427/97.3

(57) ABSTRACT

Disclosed herein is a thin film chip device, including: a substrate; a circuit layer disposed on the substrate and having coil patterns; and a functional layer formed on the circuit layer and having an embossed shape.

### CROSS REFERENCE(S) TO RELATED APPLICATIONS

This application claims the benefit under 35 U.S.C. Section 119 of Korean Patent Application Serial No. 10-2013-0046732, entitled “Thin Film Type Chip Device and Method for Manufacturing the Same” filed on Apr. 26, 2013, which is hereby incorporated by reference in its entirety into this application.

### BACKGROUND OF THE INVENTION

1. Technical Field

The present invention relates to a chip device and a method for manufacturing the same, and more particularly, to a thin film chip device which has a high electrostatic discharge (ESD) characteristic, and a method for manufacturing the same.

2. Description of the Related Art

Recently, as electronic devices such as smart phones have high specifications and multi functions while reduced in size, it is essential for electronic devices to have a chip component for removing a common mode noise in a circuit such as high speed interface using a differential transmission scheme. To keep pace with such a trend, a common mode noise filter (CMF) which has high performance while reducible in size has been developed.

### RELATED ART DOCUMENT

### Patent Document

(Patent Document 1) Korean Patent Laid-Open Publication No. 2010-0070996

### SUMMARY OF THE INVENTION

An object of the present invention is to provide a thin film chip device having a high electrostatic discharge characteristic.

Another object of the present invention is to provide a thin film device having a functional layer with a relatively large surface area, so as to have an improvement in the processing efficiency of a surge current.

Still another object of the present invention is to provide a method for manufacturing a thin film chip device having a high electrostatic discharge characteristic.

Yet another object of the present invention is to provide a method for manufacturing a thin film device having a functional layer with a relatively large surface area, so as to have an improvement in the processing efficiency of a surge current.

According to an exemplary embodiment of the present invention, there is provided a thin film chip device, including: a substrate; a circuit layer disposed on the substrate and having coil patterns; and a functional layer formed on the circuit layer and having an embossed shape.

The functional layer may have a plated film formed by performing a plating process on the circuit layer.

The functional layer may have metal films having convex-shaped surfaces and being not in contact with one another.

The functional layer may have a multilayer structure in which plural metal films are stacked on one another.

The functional layer may include: a first metal layer; and a second metal layer, wherein the second metal layer is a plated film formed by performing a plating process using the first metal layer as a metal catalytic layer.

The functional layer may have a thickness in micrometer.

The device may further include a ground electrode connected to the functional layer.

The substrate may be a ferrite magnetic substrate, and the coil patterns may have a multilayer structure.

The device may further include a cover layer covering the circuit layer, wherein the functional layer is disposed along the interface between the circuit layer and the cover layer so as to prevent a surge current generated in the cover layer from flowing into the circuit pattern.

The device may further include a cover layer covering the functional layer, wherein the coil layer includes: a first cavity defining pattern that defines a first cavity via which the coil patterns are exposed; and a first filler porting that fills the first cavity, and wherein the cover layer includes: a second cavity defining pattern that defines a second cavity via which the functional layer is exposed, the first cavity defining pattern and the second cavity defining pattern forming an external electrode for electrically connecting the thin film chip device to an external electronic device; and a second filler portion that fills the second cavity.

According to another exemplary embodiment of the present invention, there is provided a thin film chip device, including: a thin film common mode noise filter (CMF); and an electrostatic discharge protection device provided in the a thin film common mode noise filter, wherein the electrostatic discharge protection device includes a functional layer formed by performing a plating process.

The functional layer may have metal films having convex-shaped surfaces and being not in contact with one another.

The functional layer may have a multilayer structure in which plural metal films are stacked on one another.

The functional layer may include: a first metal layer; and a second metal layer, wherein the second metal layer is a plated film formed by performing an electroless plating process using the first metal layer as a metal catalytic layer.

The functional layer may be interposed between the circuit layer having multilayer coil patterns and a cover layer covering the circuit layer, wherein the circuit layer and the cover layer share an external electrode for electrically connecting the thin film chip device to an external electronic device.

According to another exemplary embodiment of the present invention, there is provided a method for manufacturing a thin film chip device, including: preparing a substrate; forming a circuit layer having coil patterns on the substrate; and forming a functional layer by performing a plating process on the circuit layer.

The forming of the functional layer may include forming a plated film in an embossed shape that protrudes upwardly.

The forming of the functional layer may include: forming a first metal layer; and forming a second metal layer by performing an electroless plating process on the first metal layer using the first metal layer as a catalytic layer.

The forming of the functional layer may include forming a plated film having a thickness in micrometer.

The preparing of the substrate may include preparing a ferrite substrate, and the forming of the circuit layer may include forming a multilayer coil on the ferrite substrate.

The method may further include, after the forming of the functional layer, forming a cover layer on the circuit layer, wherein the forming of the circuit layer may include: forming a first cavity defining pattern that defines a first cavity via which a part of the coil patterns are exposed on the substrate; and forming a first filler portion in the first cavity, and wherein the forming of the cover layer may include: forming a second cavity defining pattern that defines a second cavity via which the functional layer is exposed on the circuit layer and forms along with the first cavity defining pattern an external electrode for electrically connecting the thin film chip device to an external electronic device; and forming a second filler portion that fills the second cavity.

### BRIEF DESCRIPTION OF THE DRAWINGS

FIG. 1 is a view showing a thin film chip device according to an exemplary embodiment of the present invention;

FIG. 2 is an enlarged view of region A shown in FIG. 1;

FIGS. 3A to 3D are photographs showing functional layers of a thin film chip device according to an exemplary embodiment of the present invention;

FIG. 4 is a flow chart illustrating a manufacturing method of a thin film chip device according to the exemplary embodiment of the present invention; and

FIGS. 5A to 5D are views for illustrating a process for manufacturing a thin film chip device according to an exemplary embodiment of the present invention.

### DESCRIPTION OF THE PREFERRED EMBODIMENTS

Various advantages and features of the present invention and methods for achieving the same will become apparent from the following description of exemplary embodiments with reference to the accompanying drawings. However, the present invention may be modified in many different ways and it should not be limited to exemplary embodiments set forth herein. These exemplary embodiments may be provided so that this disclosure will be thorough and complete, and will fully convey the scope of the invention to those skilled in the art. Like reference numerals denote like elements throughout the description.

Terms used in the present specification are for explaining exemplary embodiments rather than limiting the present invention. Unless specifically mentioned otherwise, a singular form includes a plural form in the present specification. Throughout this specification, the word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In the drawings, thicknesses of films and regions are exaggerated for efficient description of technical ideas. Therefore, exemplified features may vary depending on manufacturing techniques and/or tolerance. Therefore, the exemplary embodiments of the present invention are not limited to specific features but may include variations depending on the manufacturing processes. For example, an etching region with a square shape may be rounded or may have a predetermined curvature.

Hereinafter, a thin film chip device and a method for manufacturing the same according to exemplary embodiments of the present invention will be described in detail with reference to the accompanying drawings.

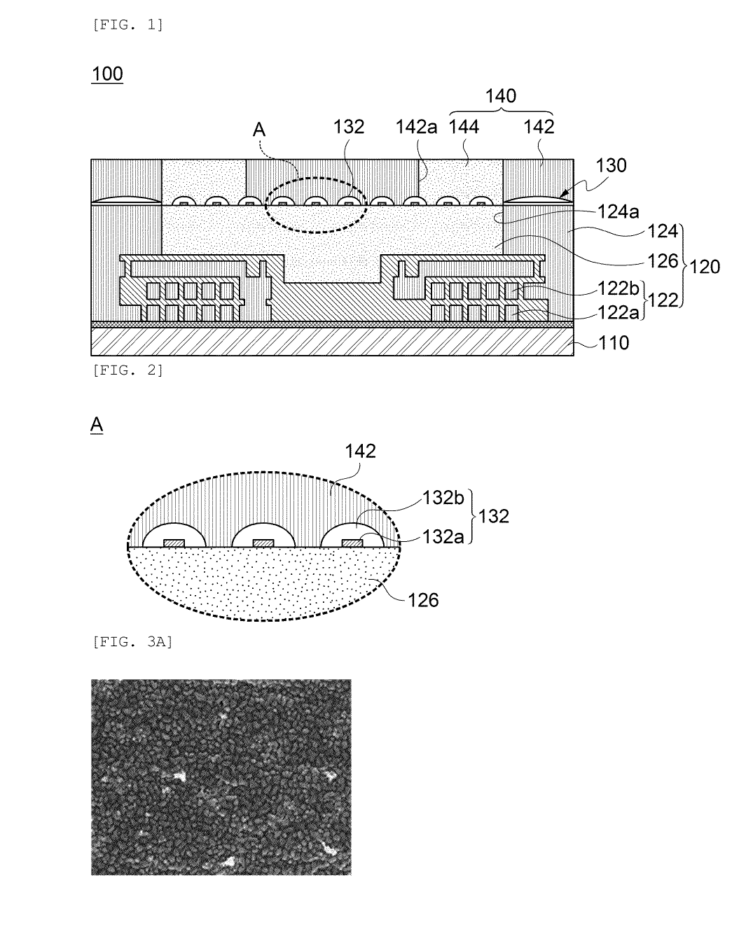

FIG. 1 is a view showing a thin film chip device according to an exemplary embodiment of the present invention; and FIG. 2 is an enlarged view of region A shown in FIG. 1.

Referring to FIGS. 1 and 2, the thin film chip device 100 according to an exemplary embodiment of the present invention is a chip component utilized by a certain electronic device in order to filter particular noises. For instance, the thin film chip device 100 may be a common mode noise filter (CMF) that is provided in an electronic device such as a smart phone and remove a common mode noise. Additionally, the thin film chip device 100 may further include an electrostatic discharge capability. To this end, the thin film chip device 100 may include an electrostatic discharge protection device for protecting the thin film chip device 100 from electrostatic discharge (ESD). In order to perform multiple functions described above, the thin film chip device 100 may include a substrate 110, a circuit layer 120, a functional layer 130, and a cover layer 140.

The substrate 110 may be a base for manufacturing the thin film chip device 100. As the substrate 110, a ferrite magnetic substrate may be used. Alternatively, a ceramic sheet, a varistor sheet, a substrate made of a liquid crystal polymer, and other various types of insulating sheets may be used for the substrate 110.

The circuit layer 120 may be disposed on the substrate 110. The circuit layer 120 may include a coil pattern 122, a first cavity defining pattern 124, and a first filler portion 126. The coil pattern 122 may a multilayer structure. For example, the coil pattern 122 may include a first coil 122a and a second coil 122b stacked on the first coil 122a. The first and second coils 122a and 122b are electrically connected to each other so as to form a coil structure having a multilayer structure.

The first cavity defining pattern 124 may define a cavity 124a on the substrate 110, via which a part of the coil pattern 122 is exposed. The first cavity defining pattern 124 may be formed on an edge region of the substrate 110 so that the cavity 124a is located at the generally central region. The first cavity defining pattern 124 may be a metal pattern electrically connected to the coil pattern 122.

The first filler portion 126 may be formed by filling the cavity 124a with a predetermined filler in order to increase the permeability and impedance characteristic of the thin film chip device 100. As the filler, a resin composite containing certain magnetic particles may be used. As an example, a ferrite-resin composite including the ferrite magnetic particles and an epoxy resin may be used for the filler.

The functional layer 130 may be provided on the interface between the circuit layer 120 and the cover layer 140 so as to absorb or block electrostatic discharge (ESD). Specifically, when a surge current is generated, the functional layer 130 allows the surge current to flow into a ground electrode (not shown) connected to the functional layer 130, and may provide a current path which is insulative before a surge current is generated and is conductive only when the surge current is generated. Accordingly, the surge current generated in the cover layer 140 is absorbed by the functional layer 130, such that the surge current may be blocked from going into the coil pattern 122 in the circuit layer 120.

The cover layer 140 may cover the functional layer 130. The cover layer 140 may include a second cavity defining pattern 142 and a second filler portion 144. The second cavity defining pattern 142 may be a metal pattern having a second cavity 142a via which the functional layer 130 is exposed. The second cavity defining pattern 142, together with the first cavity defining pattern 142, may be used as an external electrode for electrically connecting the thin film chip device 100 to an external device. In this configuration, the cover layer 140 and the circuit layer 120 may have the functional layer 130 therebetween and share the external electrode. The second filler portion 144 is formed by filling the second cavity 142a with a predetermined filler, and may be of the same with the composite used for forming the first filler portion 142.

Further, the functional layer 130 may have a plurality of metal films 132. The metal films 132 may be distributed throughout the surface of the circuit layer 120. The metal films 132 may be spaced apart from one another so that they may not be in contact with one another. The metal films 132 having a width in the lateral direction greater than a height in the protruding direction. As the height in the protruding direction increases, the thickness of the functional layer 130 is thickened, such that the performance of the functional layer may be degraded.

The metal films 132 may have a multilayer structure in which a plurality of metal layers is stacked on one another. For example, each of the metal films 132 may include a first metal layer 132a and a second metal layer 132b covering the first metal layer 132a. The first metal layer 132a may be made of a metal capable of functioning as a catalytic metal. The first metal layer 132a may be a metal layer made of at least one metal of palladium (Pd), rhodium (Rh), silver (Ag), gold (Au), cobalt (Co), nickel (Ni), and copper (Cu). The second metal layer 132b may be a plated layer formed by performing a plating process by using the first metal layer 132a as a catalytic layer. The second metal layer 132b may be a metal layer formed of various metals such as tin (Sn) on which an electroless plating process may be performed. The first metal layer 132a and the second metal layer 132b may be formed of different metals. Optionally, the first and second metal layers 132a and 132b may be formed of the same metal.

Each of the metal films 132 may have a convex-shaped surface. That is, each of the metal films 132 may protrude upwardly in a convex-shape, and may have a rounded surface. Such metal films 132 may form an embossed shape over the surface of the circuit layer 120. The functional layer 130 having an embossed shape may have larger surface area than metal films having flat surfaces. With a larger surface area, there are more paths through which surge currents may flow because of the relatively larger surface area of the metal films 312, such that surge currents may be processed accordingly.

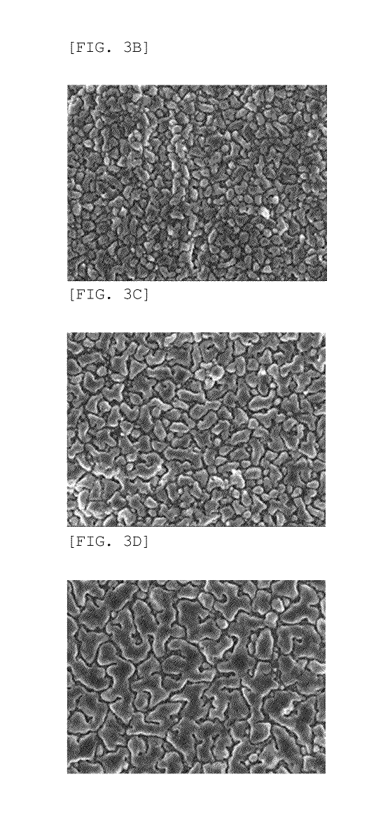

Alternatively, the metal films 132 may have an atypical shape, i.e., each of the metal films may have different shapes. To this end, the functional layer 130 may be formed by performing a plating process. FIGS. 3A to 3D are photographs showing functional layers according to exemplary embodiments of the present invention. As shown in FIGS. 3A to 3D, when the functional layer is formed by performing a plating process, it can be seen that each of the formed metal films has different shapes, i.e., an atypical shape. Here, by adjusting the condition of a plating process, the gaps between the metal films, and the size and thickness of each of the metal films may be variously adjusted. FIGS. 3A to 3D show that the size and thickness of each of the metal films may be adjusted by adjusting a time period of a plating process and the like.

Forming the functional layer 130 with a plating process enables a plating layer to have an embossed shape and to be relatively thick, compared to forming it with a thin film forming process. For example, when the functional layer is formed by a vapor deposition process such as sputtering, a metal film having a flat surface with a thickness approximately in nanometer is obtained. In contrast, when the functional layer is formed by a plating process, a metal film having an embossed surface with a thickness approximately in micrometer may be obtained. That is, for the same processing time, the functional layer formed by a plating process may have a thickness approximately ten or more times thicker than the functional layer formed by a vapor deposition process. Accordingly, the functional layer 130 has a surface which is relatively thick and embossed and thus relatively large, compared to the functional layer formed by a thin film forming process, such that the area for processing a surge current may be enlarged. Further, the functional layer 130 may reduce its own electric resistance so as to effectively absorb and block a surge current with larger area.

As described above, the thin film chip device 100 according to the exemplary embodiment of the present invention may include the substrate 110, the circuit layer 120 and the cover layer 140 stacked on the substrate 110 in this order, the functional layer 130 disposed between the circuit layer 120 and the cover layer 140, wherein the functional layer 130 may be formed of metal films 132 having an embossed shape. With this configuration, the functional layer 130 has a relatively large surface area compared to a functional layer having flat metal films, thereby allowing a surge current to flow into a ground electrode through the functional layer more easily. Accordingly, the thin film chip device according to the exemplary embodiment of the present invention includes a functional layer that absorbs a surge current and is made of metal films having an embossed shape, such that path of the surge current is multiplied, the electric resistance in the functional layer is reduced, and with a relatively large surface area, the processing efficiency of a surge current can be improved

Further, the thin film chip device 100 according to the exemplary embodiment of the present invention includes the functional layer 130 made of metal films 132 having a thickness in micrometer, such that the surge current may be more effectively and stably processed than a functional layer having a thickness in nanometer. Accordingly, since the functional layer that absorbs a surge current has a thickness in micrometer, the surge current may be more stably processed than a functional layer having a thickness in nanometer.

Hereinafter, a manufacturing method of a chip device according to an exemplary embodiment of the present invention will be described in detail. Here, redundant descriptions on the thin film chip device 100 will be omitted or simplified.

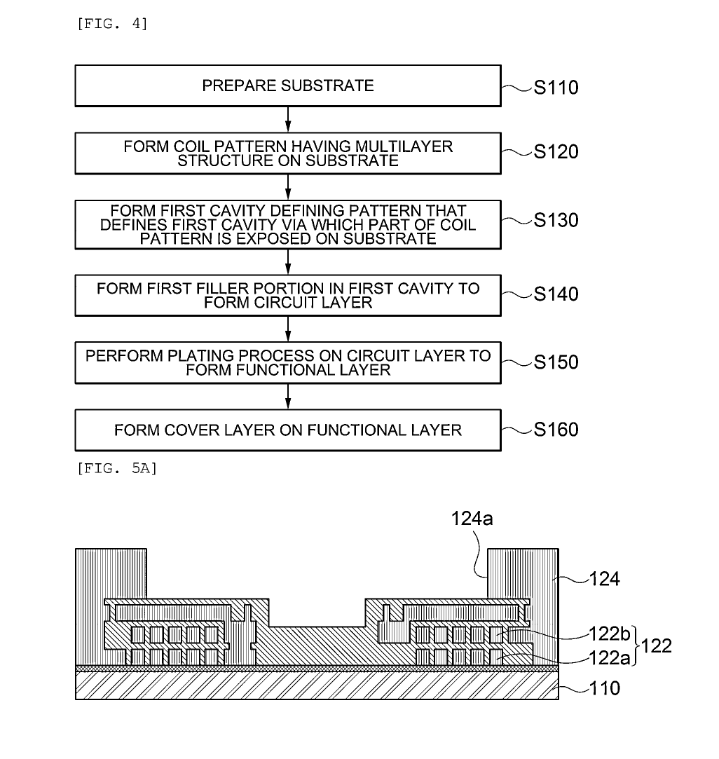

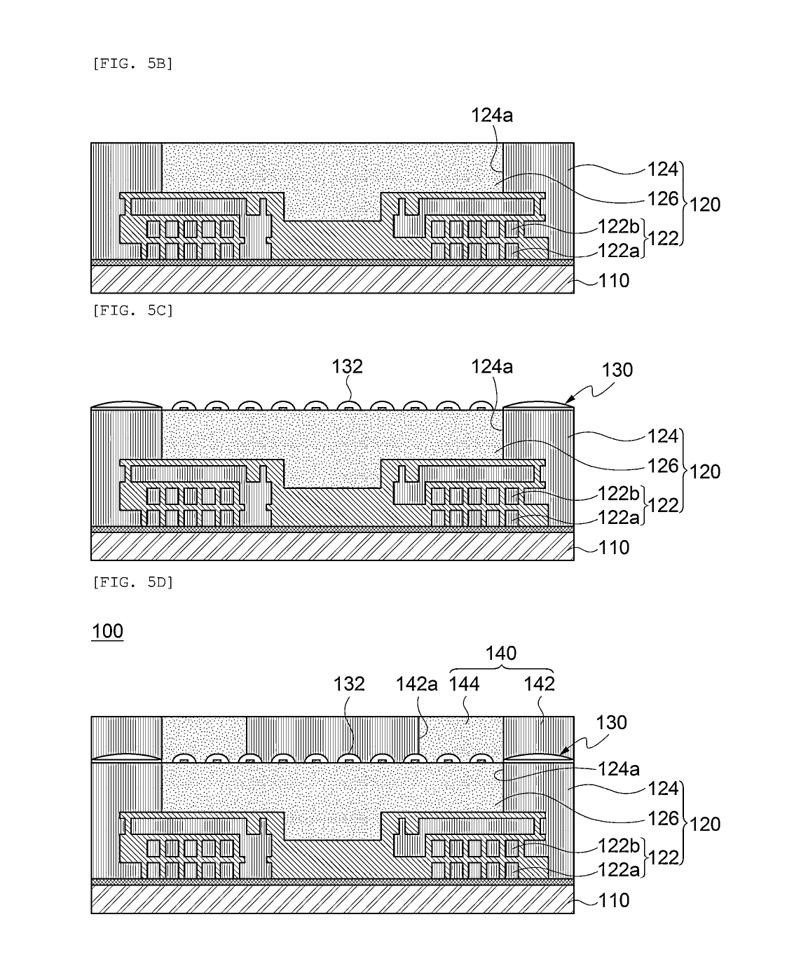

FIG. 4 is a flow chart illustrating a manufacturing method of a thin film chip device according to an exemplary embodiment of the present invention; and FIGS. 5A to 5D are views illustrating a process of manufacturing a thin film chip device according to an exemplary embodiment of the present invention.

Referring to FIGS. 4 and 5A, a substrate 110 may be prepared (S110). As the substrate 110, a substrate made of material having magnetic property may be used. For example, a ferrite magnetic substrate may be used as the substrate 110.

Coil patterns 120 having a multilayer structure may be formed on the substrate (S120). For example, a first circuit pattern 122a may be formed by performing a photo resist process and a plating process on the substrate 100, and then a second circuit pattern 122b may be formed by performing again the above processes on the result, i.e., the first circuit pattern 122a. Although the coil patterns 120 having a multilayer structure is described as an example, the number of layers of the coil pattern may be variably determined.

A first cavity defining pattern 124 for defining a first cavity 124a which exposes a part of the coil patterns 120 may be formed on the substrate 110 (S130). The forming of the first cavity defining pattern 124 may be performed by forming metal films on the results, i.e., the coil patterns 120 and then selectively removing a part of the metal films.

Turning to FIGS. 4 and 5B, a first filler portion 126 may be formed in the first cavity 124a so as to form a circuit layer 120 (S140). The forming of the first filler portion 126 may be performed by producing a predetermined filler, filling the first cavity 124a with the filler, and planarizing the filler. As the filler, a composite containing certain magnetic particles and resins may be used. The planarizing of the filler may be carried out by performing a polish process on the composite filling the first cavity 124a, with the first defining pattern 124 as a polish stop film. By doing so, the first filler portion 126 having the height and thickness generally identical to those of the first cavity defining pattern 124 may be formed in the first cavity 124a.

Turning to FIGS. 4 and 5C, a functional layer 130 may be formed by performing a plating process on the circuit layer 120 (S150). The forming of the functional layer 130 may be carried out by performing a plating process on the circuit layer 120 to form a first metal layer 132a, and performing an electroless plating process with the first metal layer 132a as a catalytic layer to form a second metal layer 132b on the first metal layer 132a. Here, since the surface of the circuit layer 120 is insulative, it is desired that the first metal layer 132a be made of a metal having a d-orbital so as to serve as a catalytic metal. For example, the first metal layer 132a may be formed by performing a plating process with at least one metal of palladium (Pd), rhodium (Rh), silver (Ag), gold (Au), cobalt (Co), nickel (Ni), and copper (Cu). The second metal layer 132b, such as tin (Sn), may be formed by using an electroless plating process with the first metal layer 132a as a catalytic layer.

Turning to FIGS. 4 and 5D, a cover layer 140 may be formed on the functional layer 130 (S160). The forming of the cover layer 140 may include forming a second cavity defining pattern 142 that defines a second cavity 142a via which a part of the functional layer 130 is exposed on the circuit layer 120, and forming a second filler portion 144 within the second cavity 142a. The second cavity defining pattern 142 may be a metal pattern having the same metal material with that of the first cavity defining pattern 124 on the circuit layer 120. The second cavity defining pattern 142 may be electrically connected with the first cavity defining pattern 124 so as to be used as an external electrode for electrically connecting the thin film chip device 100 to an external device. The second filler portion 144 may be formed by filling the second cavity 142a with the same composite as the composite used for forming the first filler portion 126.

As described above, the method for a thin film chip device according to the exemplary embodiment of the present invention may include forming the circuit layer 120 having the coil patterns 122 on the substrate 110, and forming the functional layer 130 having an embossed shape by plating a plating process on the circuit layer 120. By doing so, compared to forming a functional layer by performing a thin film forming process such as a sputtering, the manufacturing cost may be reduced since expensive equipment is not required, and the electric conductivity of the functional layer may be easily adjusted by adjusting a plating process condition. Therefore, the method for manufacturing a thin film chip device may form the functional layer having a relatively large surface area by performing a plating process, such that manufacturing cost may be reduced while the thin film chip device may have a high electrostatic discharge characteristic, compared to forming a functional layer using a thin film forming process.

As set forth above, the thin film chip device includes a functional layer that absorbs a surge current and is made of metal films having an embossed shape, such that path of the surge current is multiplied, the electric resistance in the functional layer is reduced, and with a relatively large surface area, the processing efficiency of a surge current can be improved.

Further, since the functional layer that absorbs a surge current has a thickness in micrometer, the surge current can be more stably processed than a functional layer having a thickness in nanometer.

Moreover, since the method for manufacturing a thin film chip device can form the function layer having a relatively large surface area by performing a plating process, such that manufacturing cost can be reduced while the thin film chip device may have a high electrostatic discharge characteristic, compared to forming a function layer using a thin film forming process.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the scope of concept of the invention disclosed in the specification, the scope equivalent to the disclosure and/or the scope of the technology or knowledge in the art to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A thin film chip device, comprising:
a substrate;
a circuit layer disposed on the substrate and having coil patterns; and
a functional layer formed on the circuit layer and having an embossed shape.

2. The device according to claim 1, wherein the functional layer has a plated film formed by performing a plating process on the circuit layer.

3. The device according to claim 1, wherein the functional layer has metal films having convex-shaped surfaces and being not in contact with one another.

4. The device according to claim 1, wherein the functional layer has a multilayer structure in which plural metal films are stacked on one another.

5. The device according to claim 1, wherein the functional layer includes:
a first metal layer; and
a second metal layer, wherein the second metal layer is a plated film formed by performing a plating process using the first metal layer as a metal catalytic layer.

6. The device according to claim 1, wherein the functional layer has a thickness in micrometer.

7. The device according to claim 1, further comprising a ground electrode connected to the functional layer.

8. The device according to claim 1, wherein the substrate is a ferrite magnetic substrate, and the coil patterns have a multilayer structure.

9. The device according to claim 1, further comprising a cover layer covering the circuit layer,
wherein the functional layer is disposed along the interface between the circuit layer and the cover layer so as to prevent a surge current generated in the cover layer from flowing into the circuit pattern.

10. The device according to claim 1, further comprising a cover layer covering the functional layer,
wherein the coil layer includes:
a first cavity defining pattern that defines a first cavity via which the coil patterns are exposed; and
a first filler portion that fills the first cavity, and
wherein the cover layer includes:
a second cavity defining pattern that defines a second cavity via which the functional layer is exposed, the first cavity defining pattern and the second cavity defining pattern forming an external electrode for electrically connecting the thin film chip device to an external electronic device; and
a second filler portion that fills the second cavity.

11. A thin film chip device, comprising:
a thin film common mode noise filter (CMF); and
an electrostatic discharge protection device provided in the a thin film common mode noise filter,
wherein the electrostatic discharge protection device includes a functional layer formed by performing a plating process.

12. The device according to claim 11, wherein the functional layer has metal films having convex-shaped surfaces and being not in contact with one another.

13. The device according to claim 11, wherein the functional layer has a multilayer structure in which plural metal films are stacked on one another.

14. The device according to claim 11, wherein the functional layer includes: a first metal layer; and a second metal layer, wherein the second metal layer is a plated film formed by performing an electroless plating process using the first metal layer as a metal catalytic layer.

15. The device according to claim 11, wherein the functional layer is interposed between the circuit layer having multilayer coil patterns and a cover layer covering the circuit layer, wherein the circuit layer and the cover layer share an external electrode for electrically connecting the thin film chip device to an external electronic device.

16. A method for manufacturing a thin film chip device, comprising:
preparing a substrate; forming a circuit layer having coil patterns on the substrate; and
forming a functional layer by performing a plating process on the circuit layer.

17. The method according to claim 16, wherein the forming of the functional layer includes forming a plated film in an embossed shape that protrudes upwardly.

18. The method according to claim 16, wherein the forming of the functional layer includes: forming a first metal layer; and forming a second metal layer by performing an electroless plating process on the first metal layer using the first metal layer as a catalytic layer.

19. The method according to claim 16, wherein the forming of the functional layer includes forming a plated film having a thickness in micrometer.
